(19) United States
(12) Patent Application Publication
(10) Pub. No.: US 2014/0156614 A1
(43) Pub. Date: Jun. 5, 2014

(54) MANAGING STRUCTURED DATA FIELDS WITHIN A SOCIAL MEDIA CHANNEL

(71) Applicant: Kirk Krappe, (US)

(72) Inventor: Kirk KRAPPE, Portola Valley, CA (US)

(73) Assignee: Kirk Krappe, Portolla Valley, CA (US)

(21) Appl. No.: 13/705,191

(22) Filed: Dec. 5, 2012

(51) Int. Cl. G06F 17/30

(52) U.S. Cl. CPC G06F 17/30286
USPC 707/694

(57) ABSTRACT

Managing structured data fields within a social media channel. Modifications are detected to a structured data field inside the social media channel from content passed from a document creation application that runs on a platform of a structured database management system and is supported by a business management application which supports rules for the content. The structured data field is modified by a user. The modifications are shared to the structured data field with collaboration group within the social media channel integrated within the document creation application, the modifications to the structured data field represented as structured data. Further, the collaboration group is enabled to modify the structured data. The structured data field is then updated with the structured data that is modified by the collaboration group The document creation application is further controlled if the structured data field that is updated violates a rule in the business management application.

### REFERENCE TO PRIORITY APPLICATION

This application claims priority from U.S. application Ser. No. 13/423,283 filed Mar. 19, 2012, entitled “SOCIAL MEDIA INTEGRATION AND COLLABORATION TOOLS IN A SYSTEM FOR LINKING STRUCTURED DATABASE MANAGEMENT SYSTEMS WITH DOCUMENT CREATION AND WORD PROCESSING TOOLS”, which is incorporated herein by reference in their entirety.

### TECHNICAL FIELD

The invention relates to the field of software applications. More specifically, the invention relates to managing structured data fields or sections within a social media channel.

### BACKGROUND

Increased availability of computer systems and an ability to connect the computer systems using various networks, for example intranets and the Internet, has made vast repositories of information and cloud-managed software applications available to users. In many instances, having such vast amounts of information available to the users enhances productivity.

Such advances in information accessibility and processing have created other challenges, for example management of the vast amounts of information. Many new tools have been developed to deal with an ever-expanding volume of information that is now available for consumption in an electronic form.

Some approaches to managing the vast amounts of information utilize a structured database management system. Indeed, it is highly useful to access the structured database management system and run applications, for example applications for managing customer or partner engagement, managing the contract process/lifecycle, and for automatically generating documents.

However, despite an ability to manage business relationships through an application with access to a structured database management system, most of the business relationships are memorialized using word processing software or other desktop documents and managed by manual human analysis.

Social media technology has substantially changed methods by which individuals and organizations communicate, share, and collaborate. However, despite presence of social media applications in browser-based applications, reach of such social media applications does not adequately pervade into other collaborative applications.

### SUMMARY

The above-mentioned needs are met by a computer-implemented method, a computer program product, and a system for managing structured data fields or sections within a social media channel.

An example of a computer-implemented method of managing structured data fields within a social media channel includes detecting modifications to a structured data field inside the social media channel from content passed from a document creation application that runs on a platform of a structured database management system and is supported by a business management application which supports rules for the content. The structured data field is modified by a user. The computer-implemented method also includes sharing the modifications to the structured data field with a collaboration group within the social media channel integrated within the document creation application. The modifications to the structured data field are represented as structured data. The computer-implemented method further includes enabling the collaboration group in the social media channel to modify the structured data. Further, the computer-implemented method includes updating the structured data field of the document creation application with the structured data that is modified by the collaboration group. Moreover, the computer-implemented method includes controlling the document creation application if the structured data field that is updated violates a rule in the business management application.

An example of a computer program product stored on a non-transitory computer-readable medium that when executed by a processor, performs a method for managing structured data fields within a social media channel includes detecting modifications to a structured data field inside the social media channel from content passed from a document creation application that runs on a platform of a structured database management system and is supported by a business management application which supports rules for the content. The structured data field is modified by a user. The computer program product also includes sharing the modifications to the structured data field with a collaboration group within the social media channel integrated within the document creation application. The modifications to the structured data field are represented as structured data. The computer program product further includes enabling the collaboration group in the social media channel to modify the structured data. Further, the computer program product includes updating the structured data field of the document creation application with the structured data that is modified by the collaboration group. Moreover, the computer program product includes controlling the document creation application if the structured data field that is updated violates a rule in the business management application.

An example of a system for managing structured data fields within a social media channel includes a non-transitory machine readable medium. The system also includes instructions carried by the machine-readable medium and operable to cause a programmable processor to perform detecting modifications to a structured data field inside the social media channel from content passed from a document creation application that runs on a platform of a structured database management system and is supported by a business management application which supports rules for the content, the structured data field modified by a user; to perform sharing the modifications to the structured data field with a collaboration group within the social media channel integrated within the document creation application, the modifications to the structured data field represented as structured data; to perform enabling the collaboration group in the social media channel to modify the structured data; to perform updating the structured data field of the document creation application with the structured data that is modified by the collaboration group; and to perform controlling the document creation application if the structured data field that is updated violates a rule in the business management application.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 illustrates an environment for providing a document creation application that is integrated with a social media channel with access to a business management application, in accordance with one embodiment;

FIG. 2 illustrates a method of controlling document creation applications by structured database systems, in accordance with one embodiment;

FIG. 3 illustrates an example of an interactive ribbon menu for interacting with the business management application and the structured database management system via a document creation application, in accordance with one embodiment;

FIG. 4A illustrates an example of a user interface for a spreadsheet creation application that is integrated with a social media channel, in accordance with one embodiment;

FIG. 4B illustrates an example of a user interface for a spreadsheet creation application that is integrated with a social media channel, in accordance with another embodiment;

FIG. 5 illustrates an example of a user interface for a presentation creation application that is integrated with a social media channel, in accordance with one embodiment;

FIG. 6 illustrates an example of a user interface for an electronic mail that is integrated with a social media channel, in accordance with one embodiment;

FIG. 7 is a block schematic diagram of a machine in the exemplary form of a computer system within which a set of instructions can be programmed to cause the machine to execute logic steps of the present disclosure, in accordance with one embodiment; and

FIG. 8 is a flowchart illustrating a method of managing structured data fields within a social media channel, in accordance with one embodiment.

### DETAILED DESCRIPTION OF THE EMBODIMENTS

The above-mentioned needs are met by a computer-implemented method and system for managing structured data fields within a social media channel. The following detailed description is intended to provide example implementations to one of ordinary skill in the art, and is not intended to limit the invention to the explicit disclosure, as one or ordinary skill in the art will understand that variations can be substituted that are within the scope of the invention as described.

A Web Services Description Language of a structured database management system allows communication between the document creation application and the business management application. In some embodiments, the business management application is accessed using an application programming interface (API) call from the document creation application. The document creation application is explicitly described, those with ordinary skill in the art having the benefit of the disclosure will appreciate that the document creation application can also include, but is not limited to, spreadsheet creation applications; electronic mail applications; applications designed for creating, manipulating, managing, and printing documents in a portable document format (PDF) file; rich text format (RTF) file; a web format; an unstructured data file; other types of documents; presentation creation applications; graphics editing programs; video editing programs; and website design applications.

In some embodiments, the business management application includes a business lifecycle management application that manages business processes by creating a quote for a prospect or customer, engaging and negotiating an agreement, order management and invoicing and any forms required in a business process that need a document to be communicating and interacting with the business management application. In the present disclosure, a contract creation and contract lifecycle management application accesses a cloud-based structured database management system via an add-in for a word processing application. Although a cloud-based structured database management system is explicitly described, those with ordinary skill in the art having the benefit of the disclosure will appreciate that the invention can also be implemented in a behind firewall database management system with similar effectiveness.

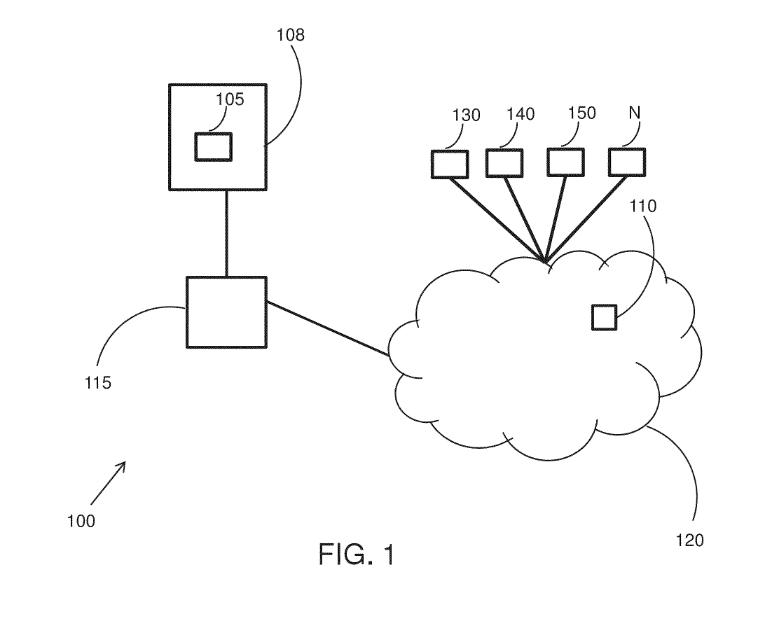

FIG. 1 illustrates an environment 100 for providing a document creation application 105 that is integrated with a social media channel with access to a business management application 110, in accordance with one embodiment. The business management application 110 is hosted on a cloud-based structured database management system 120 or a behind the firewall application. In some embodiments, the cloud-based structured database management system 120 includes a platform-as-a-service offering, for example as offered by Salesforce®, located at One Market Plaza, Suite 300, San Francisco, Calif., 94105, United States.

The business management application 110 is accessed by the document creation application 105 through a managed add-in 115 that transfers web service calls to the business management application 110 via the structured database management system 120. In one example, the add-in 115 is a web services application programming interface (API). Accordingly, data from the document creation application 105 is accessed by the business management application 110 of the structured database management system 120 via the add-in 115.

In some embodiments, the business management application 110 and the structured database management system 120 require log-in credentials. In some cases, the log-in credentials are similar for both the business management application 110 and the structured database management system 120. In one example, a user enters the log-in credentials of the structured database management system 120 via the document creation application 105.

In some embodiments, once the user logs into the document creation application 105 using the log-in credentials of the structured database management system 120, a session identifier is stored within the add-in 115 such that successive calls can be invoked in same session context until the user logs out of the structured database management system 120.

In some embodiments, the add-in 115 is configured to display one or more of interactive menus, buttons, and text fields, either via windows native to the document creation application 105, browser-based windows common to the structured database management system 120, a combination thereof, or via the document creation application 105.

In some embodiments, a browser-based form loads a dynamic interactive page from the business management application 110 in the structured database management system 120. In one example, the browser-based form loads a dynamic interactive Visualforce® page from a contract lifecycle management product in the Salesforce.com cloud. According to this example, the business management application 110 helps control improvisation to the Visualforce® page, by a customer, in accordance with organizational needs.

According to some embodiments, the business management application 110 includes a contract management application designed for contract administrators and legal users to help streamline the process of creating and maintaining contracts and associated contract and clause templates. Since such users are familiar with drafting, revising, and negotiating contracts using common word processing software, it is desirable to offer benefits and functionality of the contract management application from within a native word processing environment. Using the contract management application, contract administrators can manage complex negotiation cycles, clauses, and contract templates easily.

Social media technology has substantially changed the ways that individuals and organizations communicate, share, and collaborate. Hence, the social media technology is an effective way to manage business relationships. The present disclosure integrates social media technology as the social media channel into the business management application 110 which is accessed by the document creation application 105 through the add-in 115 and that has access to the structured database management system 120.

The document creation application 105 is run on a client computer 108 that is connected to a plurality of other client computers 130, 140, 150, . . . , N via the cloud-based structured database management system 120. The document creation application 105 is integrated with the social media channel which is a social media interface. In some embodiments, the social media channel is included in a social network external to the structured database management system 120. The add-in 115 allows users to share content or agreement document via the social media channel.

In some embodiments, the user has ability to access a plurality of social media channels. For example, the user can view a general social media feed or switch view to see social media feeds that are specific to a currently opened agreement document or to a selected structured data field.

The social media channel is built on a platform of the cloud-based structured database management system 120. For example, the add-in 115 of the business management application 110 loads the social media channel built on the cloud-based structured database management system 120 platform in a native word processing task pane providing an ability to perform a side by side view of the agreement document and social media feed.

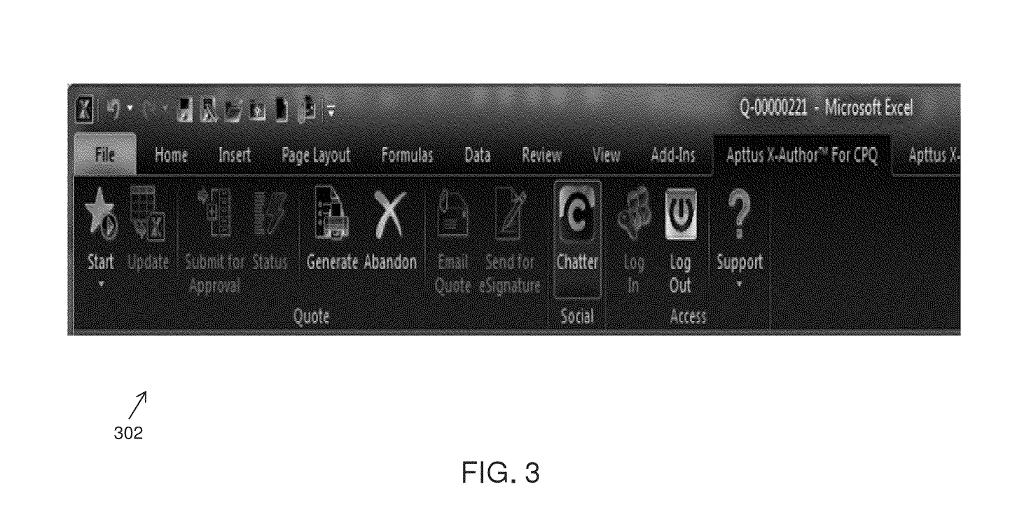

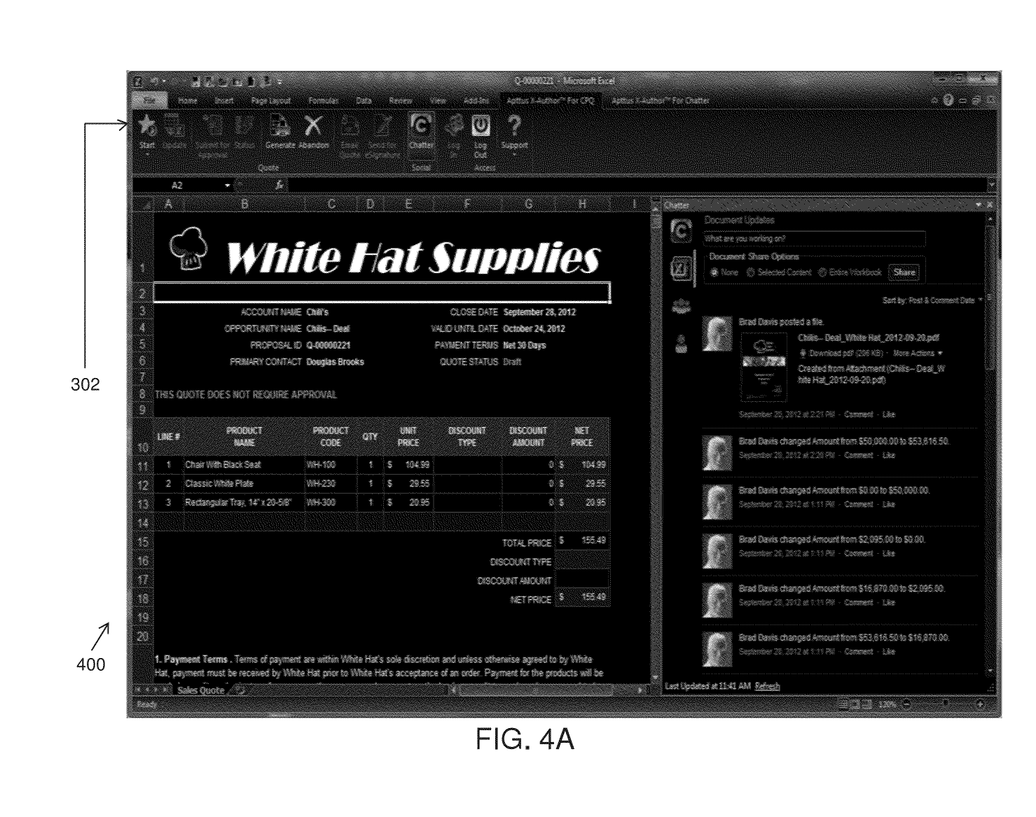

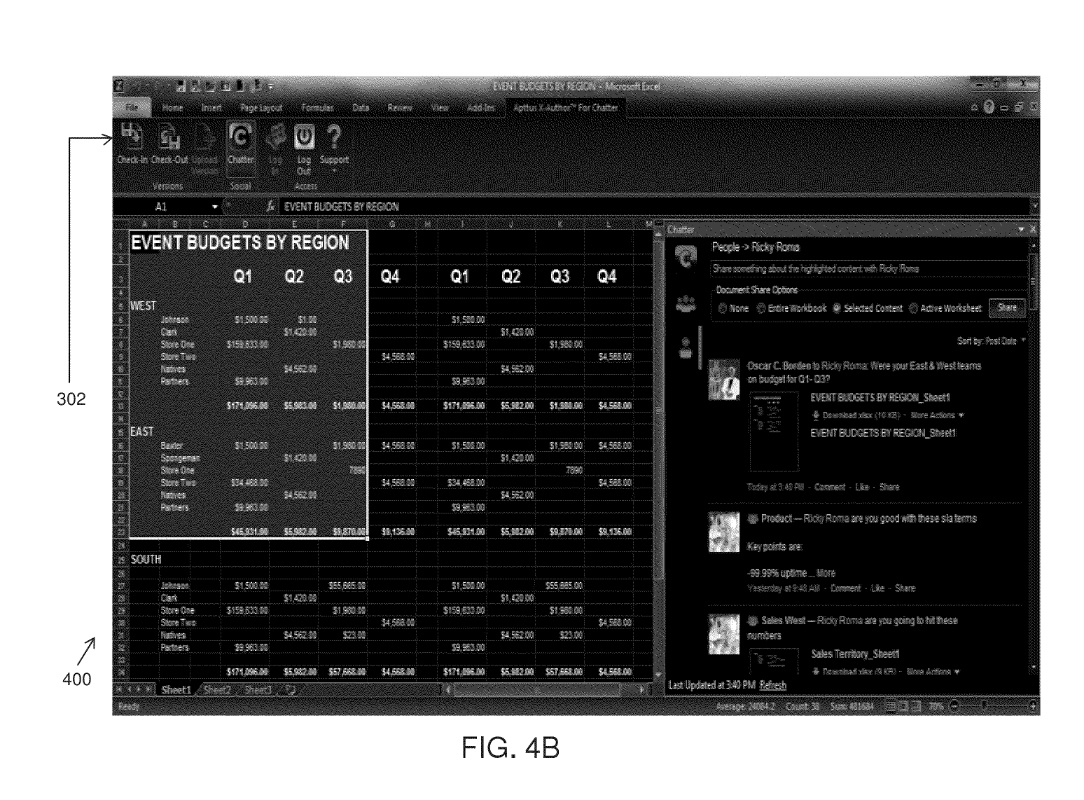

In some embodiments, an interactive ribbon menu, as described in FIG. 3, including different data management tools and present on the document creation application 105 can be used for interaction by the business management application 110 and the structured database management system 120. The interactive ribbon menu can, for instance, be part of a user interface display in a windows-type application. In one embodiment, the interactive ribbon menu can be displayed as a bar of clickable function icons, or as multiple, tab-selectable bars of different clickable function icons, for instance as will be shown and described in connection with FIGS. 4A, 4B, 5 and 6. The data management tools can include an executable data-push utility that pushes data back and forth from a structured field in the document creation application 105 to the social media channel via the structured database management system 120 and stores the data. The executable data-push utility further includes authorization tools which require the user of the document creation application 105 to provide authorization before the executable data-push utility stores the data in the structured database management system 120.

In some embodiments, one or more of the data management tools perform actions that change the data in the structured database management system 120. Some embodiments involve security protocols and permission verification check before allowing the user to change the data.

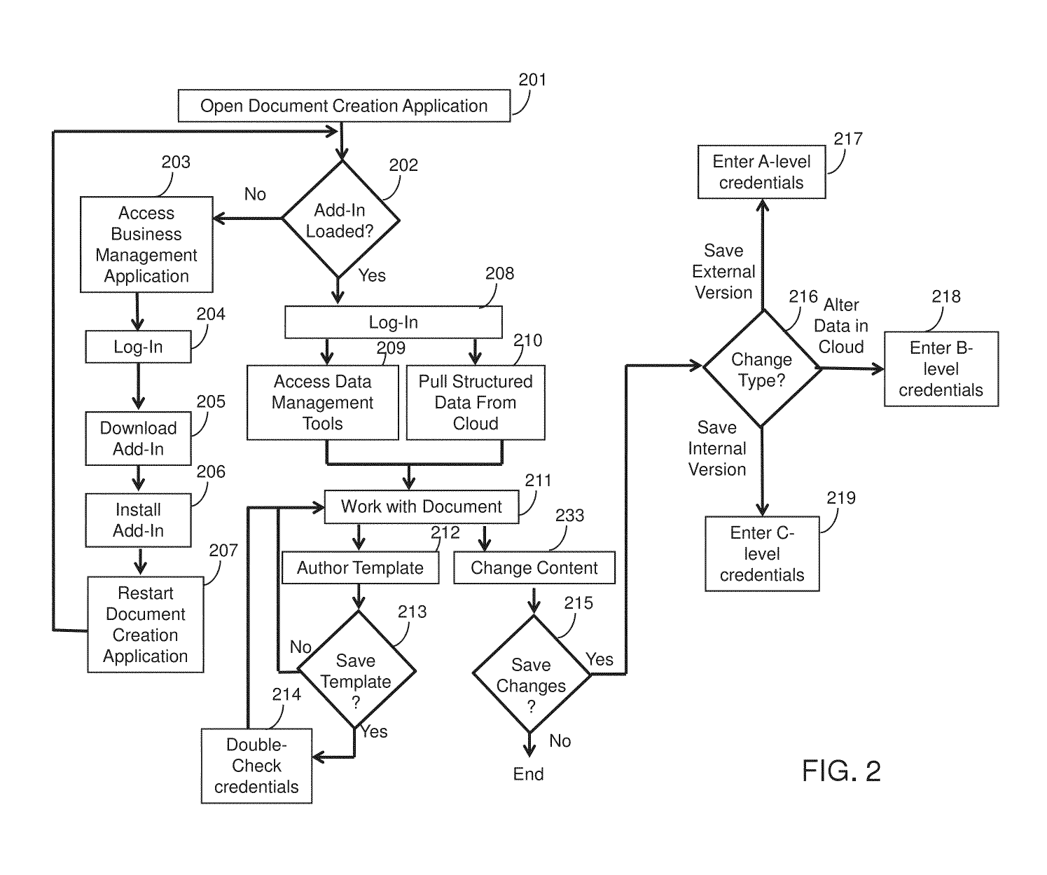

FIG. 2 illustrates a method of controlling document creation applications by structured database systems, in accordance with one embodiment. The method begins at step 201 when a user opens a document creation application, for example the document creation application 105 having examples of a word processing application or a spreadsheet creation application. At step 202, it is determined if an add-in, for example the add-in 115, is already loaded.

If the add-in is not loaded, step 203 is performed else step 208 is performed. At step 203, the user accesses a business management application, for example the business management application 110, directly. At step 204, the user logs into the business management application. The user further downloads the add-in at step 205 and installs the add-in at step 206. Once the add-in is installed, the user restarts the document creation application at step 207 to begin using the add-in. If the add-in is already loaded into the document creation application, the user logs in at step 208. In some embodiments, the document creation application asks a user to log-in when the user first attempts to use an add-in ribbon menu.

In some embodiments, logging in includes being challenged with a user name and password. In other embodiments, logging in includes the user entering a username and password and also using a security token if trying to login outside a trusted network of a company. In some embodiments, login processes at step 204 and step 208 involve entering login information of a structured database management system, for example the structured database management system 120, the business management application, or both. According to these embodiments, once the user clicks on a login button, the add-in invokes a web service call to challenge the user credential in the cloud. Upon validation of credentials of the user, the business management application sends the user a login success message along with a session id. If login is unsuccessful then it sends back a fault code for respective error.

Once the user is successfully logged in, the user can access data management tools, at step 209, using the add-in via an interface within the document creation application, pull structured data from the structured database management system cloud at step 210, and work with a document using the document creation application at step 211.

As will be explained in more detail below, the data management tools include tools for using existing templates and authoring new templates. The data management tools can be used by the business management application to control and manage the data entered in the document creation application. In some embodiments of the invention, a button in the ribbon is configured to create agreement templates. The user has an option to either checkout an existing agreement template or author an agreement template from scratch. If the user authors an original template at step 212, the user can choose to save the authored template in the structured database management system, the business management application, or both at step 213. In some embodiments, if the user chooses to save the template, the add-in double-checks the credentials of the user at step 214 to ensure that the user is authorized to save authored templates. If the user does not choose to save the template, then step 211 is performed.

Once a user changes content in the document at step 233 and is finished working with the document, the user can choose whether to save the changes at step 215. Multiple types of versions of the document can be saved and the user can also check data changes. Accordingly, at step 216, types of changes made are determined. Further, various levels of user credentials required for each type of change are determined at step 217, step 218, and at step 219. If the changes are saved as an external version, A-level credentials need to be entered at step 217. If the data is altered in the cloud, B-level credentials need to be entered at step 218. If the changes are saved as an internal version, C-level credentials need to be entered at step 219. Note that saving changes, as discussed here, can facilitate sharing the changes with other users via a social media channel, in a manner to be described below.

FIG. 3 illustrates an example of an interactive ribbon menu 302 for interacting with a business management application, for example the business management application 110, and a structured database management system, for example the structured database management system 120, via a document creation application, for example the document creation application 105, in accordance with one embodiment.

The interactive ribbon menu 302 includes a variety of tools for adding collaborative functionality and lifecycle management utility to a documents creation application. In some embodiments, the interactive ribbon menu 302 provides at least the one of following utilities: amending and saving contract agreements to the business management application; providing ability to highlight reconcilable data; providing the ability to reconcile agreement records; providing the ability to view social media feeds from within the document creation application; providing the ability to share content and documents via social media including tools, for example Salesforce Chatter, Facebook, and Twitter; providing the ability to translate content from one language to another from within the document creation application; providing the ability to create reminder tasks or schedule appointment events in relation to a currently opened agreement document; providing tools for agreement contract versioning; providing the ability to store unique versions of word processing files that are marked with an explicit version number as attachments to the business management application; and allowing contract administrators the ability to compare different versions of agreements in a side by side view.

FIG. 4A and FIG. 4B illustrate examples of user interfaces for a spreadsheet creation application 400, for example Microsoft Excel, that is integrated with a social media channel and having an interactive ribbon menu 302 for interacting with a business management application, for example the business management application 110, and a structured database management system, for example the structured database management system 120, in accordance with different embodiments. The spreadsheet creation application 400, of the document creation application, has access to the business management application that is hosted on a cloud-based structured database management system or a behind the firewall application.

In some embodiments, the business management application is accessed by the spreadsheet creation application 400 through a managed add-in, for example the add-in 115, that transfers web service calls to the spreadsheet creation application 400 via the structured database management system. Accordingly, the user accesses structured data from the structured database management system as well as the business management application via the spreadsheet creation application 400.

The interactive ribbon menu 302 includes a variety of data management tools for adding collaborative functionality and lifecycle management utility to a word processing document.

In some embodiments, the social media channel integrated with the spreadsheet creation application is configured to allow users to perform a wide variety of collaborative actions. The following is a non-exhaustive list of illustrative examples of actions that can be performed using the social media channel: create user profiles; update user status; create groups of the users; follow social media feeds of individuals, groups, and projects; share files; send invitations to other users; make recommendations; run reports; configure mobile devices to receive activity notifications; and configure privacy controls.

In one example, the user makes modifications to a structured data field, for example a smart field, in the spreadsheet creation application 400 as illustrated in FIG. 4A. In another example, the user makes modifications to the structured data field, for example a smart section, in the spreadsheet creation application 400 as illustrated in FIG. 4B. The smart field is a single cell or area including information, for example a number or a name, for example a date inside a word processing document or a cell in a spreadsheet. The smart section is an area of cells including information, for example a section of a workbook or an area inside a word processing document. The business management application detects the modifications to the structured data field in the spreadsheet creation application 400 and shares the modifications to the structured data field with a collaboration group within the social media channel integrated within the document creation application. The modifications to the structured data field are further represented as structured data. In one example, the modifications to the structured data field can be automatically shared. In another example, the modifications to the structured data field can be manually shared by a user clicking a share button in the social media channel. As per the foregoing, it may be generally stated that the modifications to the structured data field as described here and elsewhere result in an effect and outcome. In another embodiment, there can be modifications to a section of content other than the structured data field. In such an embodiment, it can be the case that modifying the section of the content products an effect and outcome similar or identical to that which would result from modification of the structured data field itself. For example, if a paragraph of content was changed inside a word processing document, the system would recognize a change has been made, which is the effect, and then perform a corresponding action based on a rule around the change, being the outcome. For instance, if the paragraph was changed and a new word was added, the system can decide to submit the document for approval as the outcome, and lock down the document such that the user cannot use the document until an approval was received, being the effect. Additionally, the change could be made within the social media channel and the document would recognize the change in the paragraph from the change in the social media channel and a similar rule could be invoked. The structured data field can also be changed in the social media channel which then results in the above described behavior of the document.

Additionally, if a cell was changed inside a spreadsheet, the system can recognize that the cell was not allowed to be changed without an approval and therefore lock down the spreadsheet, which is the effect. Once the approval has been provided by the system, being the outcome, then the document can be unlocked to enable continuation of the process as a further outcome. This can also take place in the document from a change to a structured data field or section inside the social media channel. The document and its behavior will be effected by the change in the social media channel.

The business management application then enables the collaboration group from multiple collaboration groups in the social media channel to modify the structured data. The collaboration group can be defined, functionally, using grouping features supported by the social media channel. For instance, in the social media channel, for example Facebook, a user can define a group, and other users can apply to join the group. This sort of function is typically used where multiple users have an interest in a particular subject. The group facilitates the sharing of information resources and messages between members of the group. The structured data field can either be pre-assigned to the collaboration group or followed by the collaboration group, for example if the structured data field is a dollar amount it can be pre-assigned to a collaboration group associated with sales. The collaboration group can be automatically selected or manually selected by the user. The modifications made by the collaboration group can be viewed in the social media feed of the social media channel. The business management application then updates the structured data field of the spreadsheet creation application 400 with the structured data that is modified by the collaboration group. By updating the structured data field, if the structured data field violates a rule in the business management application, then the spreadsheet creation application 400 becomes controlled by the business management application. The spreadsheet creation application 400 is controlled by initiating an approval process for the structured data field that is updated and then assigning regulatory controls to the spreadsheet creation application 400 until completion of the approval process.

The rule can pertain to functionality which is relevant to the spreadsheet creation application 400, and/or to parameters set by the user which relate to the spreadsheet creation application 400 or to data included within a document created by the spreadsheet creation application 400. For instance, suppose the user has typed information into a cell of a spreadsheet document which is defined as containing a numeric value. The rule can check the syntax of the data entered by the user, to confirm that it meets the criteria for a numeric value, for example containing no alpha characters or punctuation marks. The rule can also be set by the user or by a designer of the spreadsheet, in order to comply with requirements for the particular use to which the spreadsheet document is to be applied. For instance, if the data is a number entered into a given cell of the spreadsheet, the spreadsheet designer can have specified that approval is required for a value, entered by the user into the cell, which exceeds a designer-specified standard value. In such case, as the user enters a value into that cell of the spreadsheet, the rule can be invoked when value of the number is higher than a standard value, and an approval is required in order to accept the entered value which exceeds the standard value. The structured database application then assigns the regulatory controls to the spreadsheet creation application 400. The regulatory controls can, for instance, specify that edits to other structured data fields can be made but the spreadsheet cannot be finalized and closed, or that the user cannot perform any further work or edits to the spreadsheet, until an approval process is completed in the structured database application. Once the approval process is completed, the regulatory controls can permit that the rule can be relinquished, and then the user can continue to work in the spreadsheet creation application 400. When the regulatory controls and the approval process are used in connection with the modifications of the structured data field or other modifications to the section of the content, based on such modifications, a change and control of the document can be invoked.

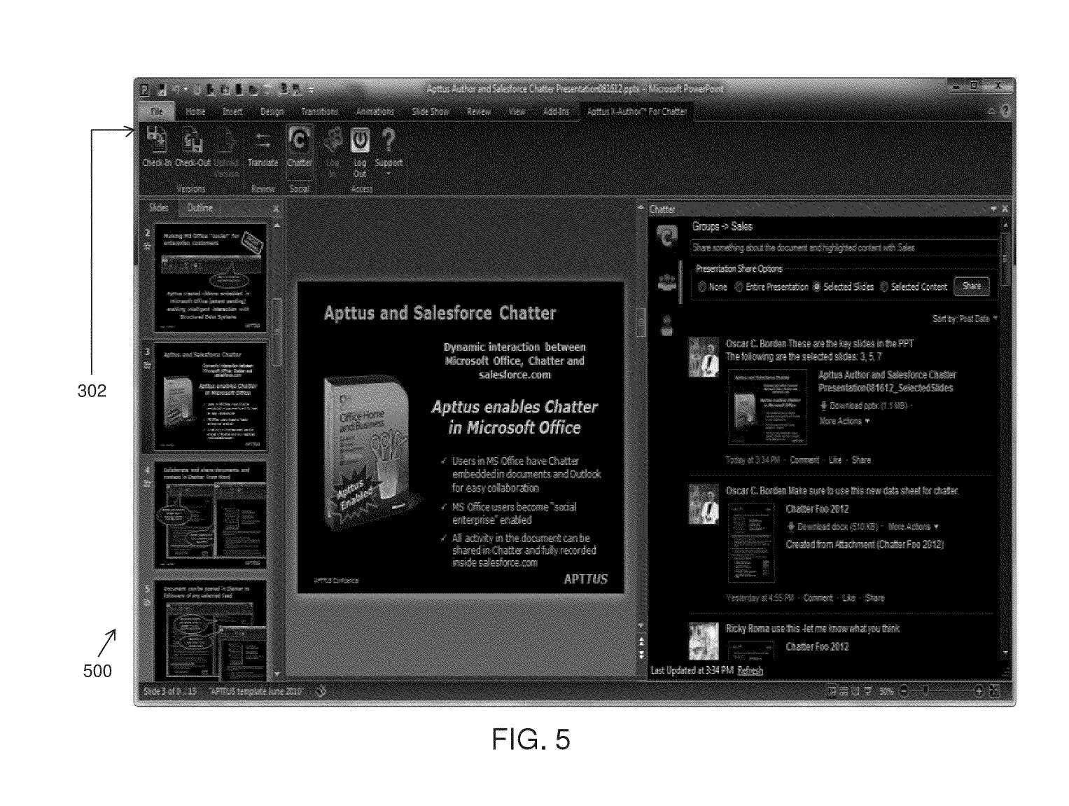

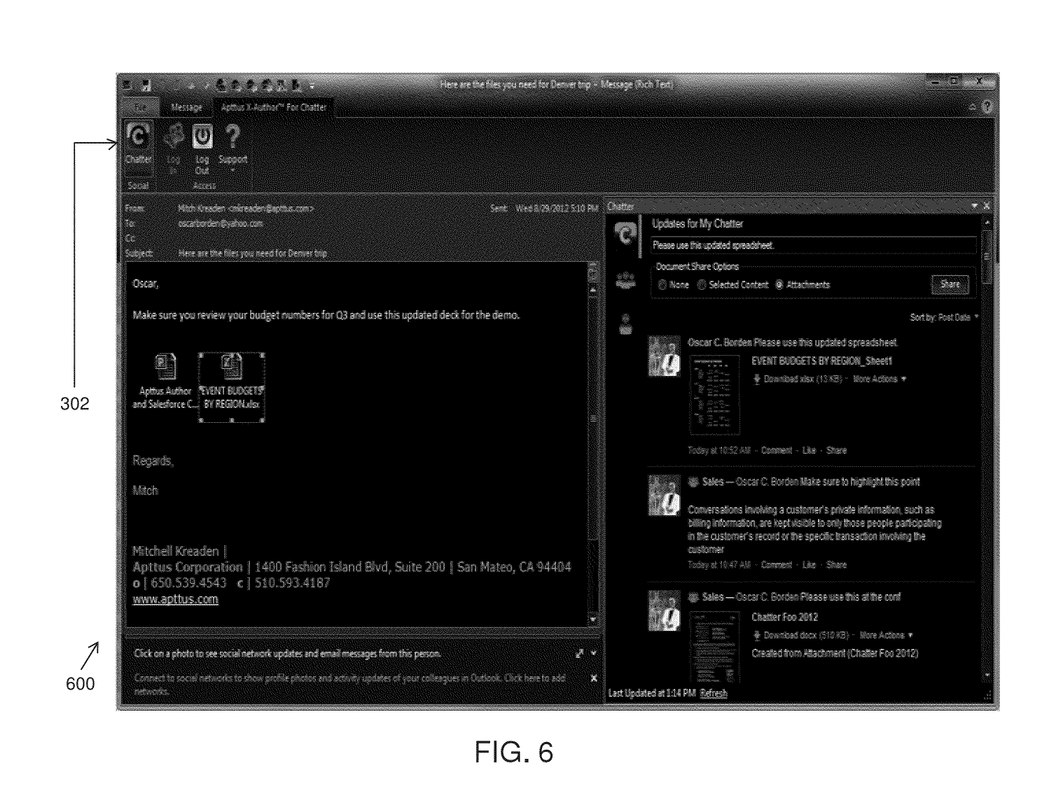

Similarly, FIG. 5 illustrates an example of a user interface for a presentation creation application 500, for example Microsoft PowerPoint, that is integrated with the social media channel, in accordance with one embodiment and FIG. 6 illustrates an example of a user interface for an electronic mail 600, for example Microsoft Outlook, that is integrated with the social media channel, in accordance with one embodiment. The structured data fields within the presentation creation application 500, the electronic mail 600 and other document creation applications are managed within the social media channel similar to the method used above for the spreadsheet creation application 400 in FIGS. 4A and 4B.

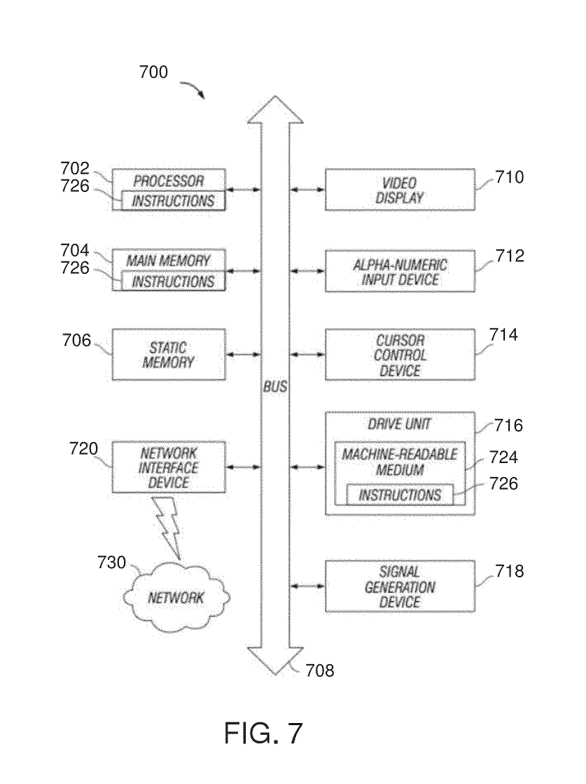

FIG. 7 is a block schematic diagram of a machine in the exemplary form of a computer system 700 within which a set of instructions can be programmed to cause the machine to execute logic steps of the present disclosure, in accordance with one embodiment. In alternative embodiments, the machine can include a network router, a network switch, a network bridge, personal digital assistant (PDA), a cellular telephone, a Web appliance or a machine capable of executing a sequence of instructions that specify actions to be taken by that machine.

The computer system 700 includes a processor 702, a main memory 704 and a static memory 706, which communicate with each other via a bus 708. The computer system 700 can further include a display unit 710, for example, a liquid crystal display (LCD) or a cathode ray tube (CRT). The computer system 700 also includes an alphanumeric input device 712, for example a keyboard; a cursor control device 714, for example a mouse; a disk drive unit 716, a signal generation device 718, for example a speaker, and a network interface device 720.

The disk drive unit 716 includes a machine-readable medium 724 on which is stored a set of executable instructions 726 embodying any one, or all, of the methodologies described herein below. The machine-readable medium 724 can, for instance, include a portable medium separately acquired and installed by the user, for example a preprogrammed CD bearing program software code, for instance the instructions 726. The instructions 726 are also shown to reside, completely or at least partially, within the main memory 704 and/or within the processor 702. The instructions 726 can further be transmitted or received over a network 730 by means of a network interface device 720.

In contrast to the system 700 shown in FIG. 7 and discussed above, a different embodiment uses logic circuitry instead of computer-executed instructions to implement processing entities. Depending upon the particular requirements of the application in the areas of speed, expense, tooling costs, and the like, this logic can be implemented by constructing an application-specific integrated circuit (ASIC) having thousands of tiny integrated transistors. Such an ASIC can be implemented with complementary metal oxide semiconductor (CMOS), transistor-transistor logic (TTL), very large systems integration (VLSI), or another suitable construction. Other alternatives include a digital signal processing chip (DSP), discrete circuitry (for example, resistors, capacitors, diodes, inductors, and transistors), field programmable gate array (FPGA), and programmable logic array (PLA), programmable logic device (PLD).

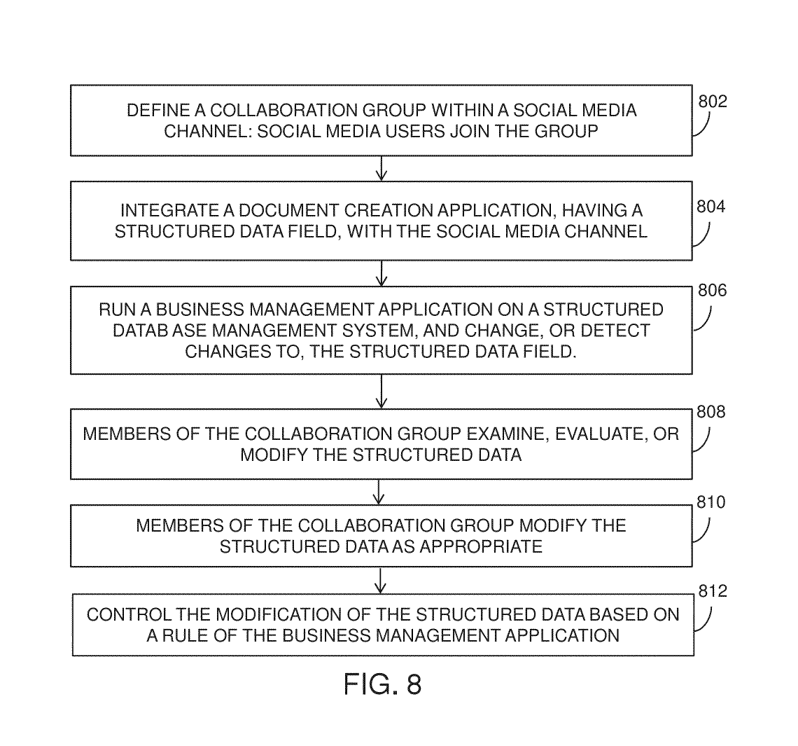

The use of a document creation application, which supports a structured data field which is modifiable by users, with a social media channel to facilitate sharing of changes and collaborative work between users, employing the techniques described above, will now be described, with reference to the flowchart of FIG. 8.

Within the social media channel, a collaboration group is defined, at step 802, and users of the social media channel join the group. This can be done, for example, in the social medium channel Facebook, using the group features supported by the social media channel.

A document creation application is created, to generate a document having, for example, a structured data field. The document creation application can for instance be a spreadsheet creation application, a word-processing document creation application, or a presentation creation application for generating slide sets, block diagrams, flowcharts, or other illustrative images. The document creation application is then integrated, at step 804, with the social media channel.

Because of the integration of the document with the social media channel, and the membership of the users of the social media channel with the group, the group members have access to the integrated document creation application, and have access to observe and change the structured data field. They can, for instance, employ systems that have graphical user interfaces as illustrated in FIGS. 3, 4A, 4B, 5 and 6, with the accompanying written descriptions given above.

A user can make a change to the structured data field, generally as described in connection with the elements 216, 217, 218, and 219 of FIG. 2, and the accompanying written description above. In accordance with one embodiment, the change is detected, at step 806, by a business management application that runs on a platform of a structured database management system.

The change is shared with the members of the collaboration group within the social media channel which had been integrated within the document creation application. The users can be notified by a suitable message or other notification, as supported by the particular social media channel. One possible method of providing such notification is by an electronic mail message that is broadcast to each member of the collaboration group.

With receipt of the notification, the members of the collaboration group are authorized or otherwise enabled to examine, evaluate, or modify the structured data, and the change thereto at step 808. As appropriate, the collaboration group, or a designated subset thereof, can make a further change to the structured data, at step 810. Again, this change can be made as per the above-referenced elements of FIG. 2, and can be done using a user interface as described in FIGS. 3 through 6, as referred to above.

If the business management application imposes any rule that can restrict modification of the structured data field, then the modifications described above can be limited or prohibited, at step 812, based on violation of the rule caused by the change.

It is to be understood that embodiments may be used as or to support software programs or software modules executed upon some form of processing core (for example the CPU of a computer) or otherwise implemented or realized upon or within a machine or computer readable medium. A machine-readable medium includes any mechanism for storing or transmitting information in a form readable by a machine, for example a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, or any other type of media suitable for storing or transmitting information.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A computer-implemented method for managing structured data fields within a social media channel, the computer-implemented method comprising:
detecting modifications to a structured data field inside the social media channel from content passed from a document creation application that runs on a platform of a structured database management system and is supported by a business management application which supports rules for the content, wherein the structured data field is modified by a user;
sharing the modifications to the structured data field with a collaboration group within the social media channel integrated within the document creation application, wherein the modifications to the structured data field are represented as structured data;
enabling the collaboration group in the social media channel to modify the structured data;
updating the structured data field of the document creation application with the structured data that is modified by the collaboration group; and
controlling the document creation application if the structured data field that is updated violates a rule in the business management application.

2. The computer-implemented method as claimed in claim 1, wherein:
the structured data field comprises a smart field and a smart section,
the modifications to the structured data field results in an effect and outcome, and
a section of the content, other than the structured data field, is modified, resulting in a similar effect and outcome as the modifications to the structured data field.

3. The computer-implemented method as claimed in claim 1, wherein the document creation application comprises one or more of a word processing application, a spreadsheet creation application, a presentation creation application, a web format, an unstructured data file, a rich text format file, a portable document file, a document, and an electronic mail application.

4. The computer-implemented method as claimed in claim 3, wherein the document creation application is configured with an add-in comprising instructions for linking the document creation application with the business management application.

5. The computer-implemented method as claimed in claim 1, wherein the structured data field is one of pre-assigned to the collaboration group and followed by the collaboration group.

6. The computer-implemented method as claimed in claim 2, wherein controlling the document creation application comprises:
initiating an approval process for the structured data field that is updated;
assigning regulatory controls to the document creation application until completion of the approval process; and
invoking change and control of the document creation application based on the change to one of the structured data field and the section of the content.

7. The computer-implemented method as claimed in claim 1, wherein the business management application comprises a business lifecycle management application that manages business processes.

8. The computer-implemented method as claimed in claim 1, wherein the business management application comprises a contract creation and contract lifecycle management application.

9. The computer-implemented method as claimed in claim 1, wherein the structured database management system comprises a cloud-based structured database management system.

10. The computer-implemented method as claimed in claim 1, wherein the social media channel is comprised in a social network external to the structured database management system.

11. A computer program product stored on a non-transitory computer-readable medium that when executed by a processor, performs a method for managing structured data fields within a social media channel, the computer-implemented method comprising:
detecting modifications to a structured data field inside the social media channel from content passed from a document creation application that runs on a platform of a structured database management system and is supported by a business management application which supports rules for the content, wherein the structured data field is modified by a user;
sharing the modifications to the structured data field with a collaboration group within the social media channel integrated within the document creation application, wherein the modifications to the structured data field are represented as structured data;
enabling the collaboration group in the social media channel to modify the structured data;
updating the structured data field of the document creation application with the structured data that is modified by the collaboration group; and
controlling the document creation application if the structured data field that is updated violates a rule in the business management application.

12. The computer program product as claimed in claim 11, wherein:
the structured data field comprises a smart field and a smart section,
the modifications to the structured data field results in an effect and outcome, and
a section of the content, other than the structured data field, is modified, resulting in a similar effect and outcome as the modifications to the structured data field.

13. The computer program product as claimed in claim 11, wherein the document creation application comprises one or more of a word processing application, a spreadsheet creation application, a presentation creation application, a web format, an unstructured data file, a rich text format file, a portable document file, a document, and an electronic mail application.

14. The computer program product as claimed in claim 13, wherein the document creation application is configured with an add-in comprising instructions for linking the document creation application with the business management application.

15. The computer program product as claimed in claim 11, wherein the structured data field is one of pre-assigned to the collaboration group and followed by the collaboration group.

16. The computer program product as claimed in claim 12, wherein controlling the document creation application comprises:
initiating an approval process for the structured data field that is updated;
assigning regulatory controls to the document creation application until completion of the approval process; and
invoking change and control of the document creation application based on the change to one of the structured data field and the section of the content.

17. The computer program product as claimed in claim 11, wherein the business management application comprises a business lifecycle management application that manages business processes.

18. The computer program product as claimed in claim 11, wherein the business management application comprises a contract creation and contract lifecycle management application.

19. The computer program product as claimed in claim 11, wherein the structured database management system comprises a cloud-based structured database management system.

20. The computer program product as claimed in claim 11, wherein the social media channel is comprised in a social network external to the structured database management system.

21. A system for managing structured data fields within a social media channel, the system comprising:
a non-transitory machine readable medium; and
instructions carried by the machine-readable medium and operable to cause a programmable processor to perform:
detecting modifications to a structured data field inside the social media channel from content passed from a document creation application that runs on a platform of a structured database management system and is supported by a business management application which supports rules for the content, wherein the structured data field is modified by a user;
sharing the modifications to the structured data field with a collaboration group within the social media channel integrated within the document creation application, wherein the modifications to the structured data field are represented as structured data;
enabling the collaboration group in the social media channel to modify the structured data;
updating the structured data field of the document creation application with the structured data that is modified by the collaboration group; and
controlling the document creation application if the structured data field that is updated violates a rule in the business management application.

22. The system as claimed in claim 21, wherein:
the structured data field comprises a smart field and a smart section,
the modifications to the structured data field results in an effect and outcome, and
a section of the content, other than the structured data field, is modified, resulting in a similar effect and outcome as the modifications to the structured data field.
